(19) United States
(12) Patent Application Publication
(10) Pub. No.: US 2024/0383251 A1
(43) Pub. Date: Nov. 21, 2024

(54) LIQUID EJECTION APPARATUS AND METHOD OF CONTROLLING LIQUID EJECTION APPARATUS

(71) Applicant: SEIKO EPSON CORPORATION, TOKYO (JP)

(72) Inventors: Hirokazu FUJII, SHIOJIRI-SHI (JP); Satoru KOBAYASHI, SHIOJIRI-SHI (JP)

(21) Appl. No.: 18/665,966

(22) Filed: May 16, 2024

(30) Foreign Application Priority Data
May 16, 2023 (JP) 2023-080647

(51) Int. Cl. B41J 2/165; B41J 2/17; B41J 2/21; B41J 3/407

(52) U.S. Cl. CPC B41J 2/16523; B41J 2/1721; B41J 2/2114; B41J 3/4078; B41J 2202/03

(57) ABSTRACT

A liquid ejection apparatus includes a liquid ejection unit including a glue belt including a conveyance surface which conveys a cloth and to which an adhesive is applied, a first nozzle group configured to eject a first liquid to the cloth conveyed by the glue belt, and a second nozzle group configured to eject a second liquid, a movement mechanism for reciprocating the liquid ejection unit in a first direction and a second direction opposite to the first direction, a softening agent receiving unit for receiving the second liquid discharged as a waste liquid from the liquid ejection unit reciprocating, and a cleaning unit for cleaning at least a part of the glue belt, wherein the first liquid is different from the second liquid, the second liquid contains a softening agent, the first nozzle group ejects the first liquid to the glue belt as a waste, and the second nozzle group ejects the second liquid to the softening agent receiving unit as a waste.

The present application is based on, and claims priority from JP Application Serial Number 2023-080647, filed May 16, 2023, the disclosure of which is hereby incorporated by reference herein in its entirety.

### BACKGROUND

### 1. Technical Field

The present disclosure relates to a liquid ejection apparatus such as a printer, and a method of controlling the liquid ejection apparatus.

### 2. Related Art

For example, as described in JP-A-2015-202629, there is a printing apparatus as an example of a liquid ejection apparatus that ejects ink as an example of a liquid from an inkjet head to perform printing. The inkjet head performs printing by ejecting the ink from nozzles onto a recording medium which is an example of a cloth conveyed by a conveyance belt which is an example of a glue belt.

The printing apparatus performs waste ejection of the ink for preventing clogging of nozzles toward a flushing region on the conveyance belt. The printing apparatus cleans the ink adhering to the conveyance belt with a belt cleaning unit as an example of a cleaning unit.

JP-A-2015-202629 is an example of the related art.

By using a softening agent for printing, it is possible to enhance a color forming property of printing. However, it is difficult to remove the softening agent attached to the glue belt by washing. When removing the softening agent from the glue belt, there is a possibility that an adhesive component of the glue belt is removed together with the softening agent.

### SUMMARY

A liquid ejection apparatus that solves the problem described above includes a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid, a movement mechanism configured to reciprocate the liquid ejection unit in a first direction and a second direction opposite to the first direction, a softening agent receiving unit configured to receive the second liquid discharged as a waste liquid from the liquid ejection unit reciprocated by the movement mechanism, and a cleaning unit configured to clean at least a part of the glue belt, wherein the first liquid is different from the second liquid, the second liquid is a liquid containing a softening agent, the first nozzle group is configured to eject the first liquid to the glue belt as a waste, and the second nozzle group is configured to eject the second liquid to the softening agent receiving unit as a waste.

A method of controlling a liquid ejection apparatus that solves the problem described above is a method of controlling a liquid ejection apparatus including a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid, a movement mechanism configured to reciprocate the liquid ejection unit in a first direction and a second direction opposite to the first direction, a softening agent receiving unit configured to receive the second liquid discharged as a waste liquid from the liquid ejection unit reciprocated by the movement mechanism, and a cleaning unit configured to clean at least a part of the glue belt, wherein the first liquid is different from the second liquid, and the second liquid is a liquid containing a softening agent, the method including ejecting, by the first nozzle group, the first liquid to the glue belt as a waste, and ejecting, by the second nozzle group, the second liquid to the softening agent receiving unit as a waste.

### BRIEF DESCRIPTION OF THE DRAWINGS

FIG. 1 is a schematic diagram of an embodiment of a liquid ejection apparatus.

FIG. 2 is a schematic diagram of a liquid ejection unit.

FIG. 3 is a schematic diagram of the liquid ejection unit and a maintenance unit.

FIG. 4 is a schematic diagram of the liquid ejection unit and the maintenance unit.

FIG. 5 is a schematic diagram of the liquid ejection unit and the maintenance unit.

FIG. 6 is a schematic diagram of the liquid ejection unit and a glue belt.

FIG. 7 is a schematic diagram of the liquid ejection unit and the glue belt.

FIG. 8 is a schematic diagram of the liquid ejection unit and the glue belt.

FIG. 9 is a schematic diagram of the liquid ejection unit and the glue belt.

FIG. 10 is a schematic diagram of the liquid ejection unit and the glue belt.

FIG. 11 is a schematic diagram of the liquid ejection unit and the glue belt.

FIG. 12 is a schematic diagram of the liquid ejection unit and the glue belt.

FIG. 13 is a schematic diagram of the liquid ejection unit and the glue belt.

FIG. 14 is a schematic diagram of the liquid ejection unit and the glue belt.

FIG. 15 is a schematic diagram of the liquid ejection unit and the glue belt.

FIG. 16 is a schematic diagram of the liquid ejection unit and the glue belt.

FIG. 17 is a schematic diagram of the liquid ejection unit and the glue belt.

FIG. 18 is a schematic diagram of the liquid ejection unit and the glue belt.

FIG. 19 is a schematic diagram of the liquid ejection unit and the glue belt.

FIG. 20 is a schematic diagram of the liquid ejection unit and the glue belt.

FIG. 21 is a schematic diagram of the liquid ejection unit and the glue belt.

### DESCRIPTION OF EMBODIMENTS

### Embodiment

An embodiment of a liquid ejection apparatus and a method of controlling the liquid ejection apparatus will hereinafter be described with reference to the drawings. The liquid ejection apparatus is, for example, an inkjet printer that ejects ink as an example of a liquid on cloth to thereby print images such as characters or photographs.

In the drawings, assuming that a liquid ejection apparatus 11 is placed on a horizontal plane, a direction of gravity is represented by a Z axis, and directions along the horizontal plane are represented by an X axis and a Y axis. The X axis, the Y axis, and the Z axis are perpendicular to each other.

### Liquid Ejection Apparatus

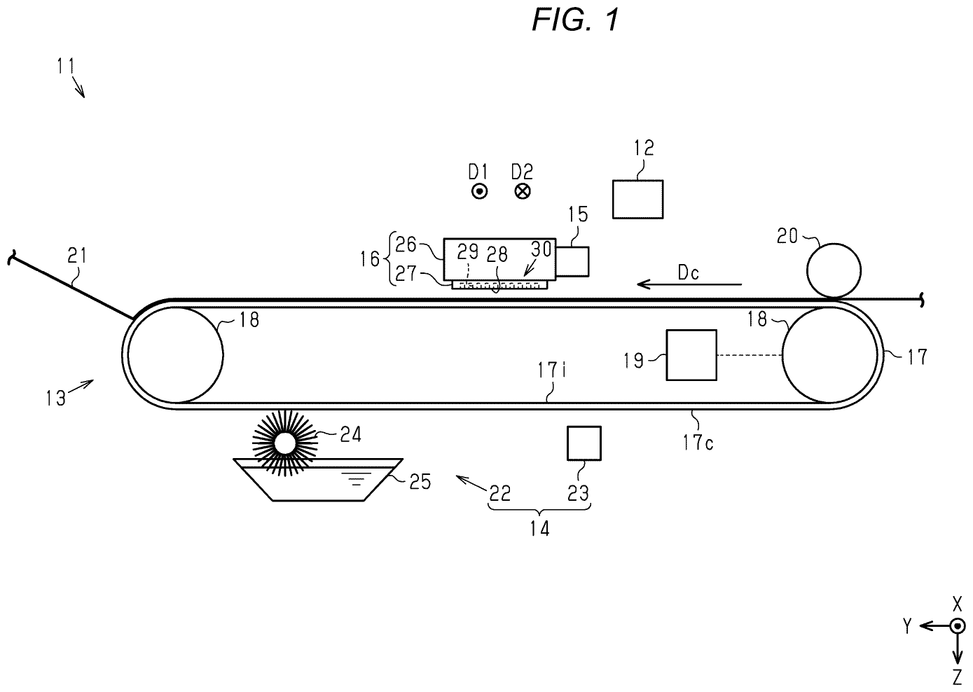

As shown in FIG. 1, the liquid ejection apparatus 11 includes a controller 12, a conveyance mechanism 13, a cleaning mechanism 14, a movement mechanism 15, and a liquid ejection unit 16.

The controller 12 integrally controls driving of each mechanism in the liquid ejection apparatus 11 to control various operations executed in the liquid ejection apparatus 11.

The controller 12 can be configured as a circuit including α: one or more processors that execute various types of processing in accordance with a computer program, β: one or more dedicated hardware circuits that execute at least some of the various types of processing, or γ: a combination thereof. The hardware circuit is, for example, an application specific integrated circuit. The processor includes a CPU and memories such as a RAM and a ROM, and the memories store program codes or commands configured to make the CPU execute the processing. The memory, that is, a computer-readable medium includes all readable medium that can be accessed by a general-purpose or dedicated computer.

The conveyance mechanism 13 includes a glue belt 17. The conveyance mechanism 13 can include two or more conveyance rollers 18, a drive source 19, and a pressing unit 20. The conveyance mechanism 13 includes, for example, two conveyance rollers 18. The drive source 19 rotates at least one of the conveyance rollers 18.

The glue belt 17 is wound around two or more of the conveyance rollers 18. The glue belt t 17 has an inner circumferential surface 17i and a conveyance surface 17c. The inner circumferential surface 17i is a surface that makes contact with the two or more conveyance rollers 18. The conveyance surface 17c is an outer surface. The conveyance surface 17c is a surface for conveying a cloth 21. An adhesive is applied to the conveyance surface 17c. The glue belt 17 bonds the cloth 21 to the conveyance surface 17c to thereby support the cloth 21.

The glue belt 17 circulates as the drive source 19 rotates the conveyance roller 18. In FIG. 1, the glue belt 17 circulates counterclockwise to thereby convey the cloth 21 in a conveyance direction Dc. Since the glue belt 17 conveys the cloth 21 in a bonded state, it is possible for the glue belt 17 to convey the cloth 21 in a stable posture.

After being conveyed by the conveyance mechanism 13, the cloth 21 is separated from the conveyance surface 17c by being pulled by, for example, another apparatus. The conveyance mechanism 13 can also include a separating unit for separating the cloth 21 from the conveyance surface 17c. The separating unit is, for example, a roller around which the cloth 21 is wound.

The pressing unit 20 is configured to press the cloth 21 against the glue belt 17. The pressing unit 20 is, for example, a roller. By the pressing unit 20 pressing the cloth 21 against the glue belt 17, the cloth 21 is bonded to the conveyance surface 17c.

### Cleaning Mechanism

As shown in FIG. 1, the cleaning mechanism 14 can include a cleaning unit 22 and a drying unit 23.

The cleaning unit 22 is configured to clean at least a part of the glue belt 17. The cleaning unit 22 can include a brush 24 and a reservoir tank 25.

The brush 24 makes contact with the conveyance surface 17c to thereby clean the conveyance surface 17c. Thus, the foreign matter is removed from the conveyance surface 17c. As a result, a possibility that dirt is transferred to the cloth 21, a possibility that adhesive force to the cloth 21 is lost, and the like are reduced. It is possible for the brush 24 to rotate while coming contact with and being driven by the glue belt 17, or to be driven by a motor not shown to rotate.

The reservoir tank 25 is configured to store the cleaning liquid. The cleaning liquid is a liquid for cleaning the glue belt 17. The cleaning liquid is, for example, water. The cleaning liquid to be stored in the reservoir tank 25 can be supplied and discharged so as to be replaced with a predetermined amount of new cleaning liquid every predetermined time.

The reservoir tank 25 is positioned such that a part of the brush 24 is immersed in the cleaning liquid stored therein. In other words, a part of the brush 24 is immersed in the cleaning liquid. The brush 24 comes into contact with the conveyance surface 17c in a state of being wet with the cleaning liquid. As a result, it becomes easy to remove a foreign matter from the conveyance surface 17c.

The drying unit 23 is configured to dry the conveyance surface 17c that has been cleaned by the cleaning unit 22. When the glue belt 17 is cleaned with the brush 24 wet with the cleaning liquid, the conveyance surface 17c is wet with the cleaning liquid. Therefore, the drying unit 23 dries the conveyance surface 17c wet with the cleaning liquid. It is possible for the drying unit 23 to dry the conveyance surface 17c by, for example, heating the conveyance surface 17c, or dry the conveyance surface 17c by blowing air to the conveyance surface 17c.

### Movement Mechanism

The movement mechanism 15 reciprocates the liquid ejection unit 16 in a first direction D1 and a second direction D2. The second direction D2 is a direction opposite to the first direction D1. In the present embodiment, the first direction D1 and the second direction D2 are directions parallel to the X axis.

### Liquid Ejection Unit

The liquid ejection unit 16 is capable of ejecting the liquid onto the cloth 21 conveyed. The liquid ejection unit 16 can include a carriage 26 and one or more heads 27. The head 27 is mounted on the carriage 26.

The head 27 is configured to eject the liquid. The cloth 21 is scanned with the head 27. The head 27 ejects the liquid while moving in the first direction D1 or the second direction D2 to thereby perform printing on the cloth 21 supported by the glue belt 17. The head 27 ejects the liquid to the cloth 21 in a state in which the conveyance is stopped. The liquid ejection apparatus 11 according to the present embodiment is a serial printer.

The head 27 has a nozzle surface 28. A plurality of nozzles 29 opens on the nozzle surface 28. Among the plurality of nozzles 29, a group of the nozzles 29 that eject liquid of the same type is also referred to as a nozzle group 30. The liquid ejection unit 16 includes a plurality of nozzle groups 30. The plurality of nozzle groups 30 may eject respective liquids different from each other. At least two of the plurality of nozzle groups 30 may eject the same liquid. The liquid ejection unit 16 ejects the liquids from the plurality of nozzle groups 30 to the cloth 21 conveyed by the glue belt 17 to perform printing.

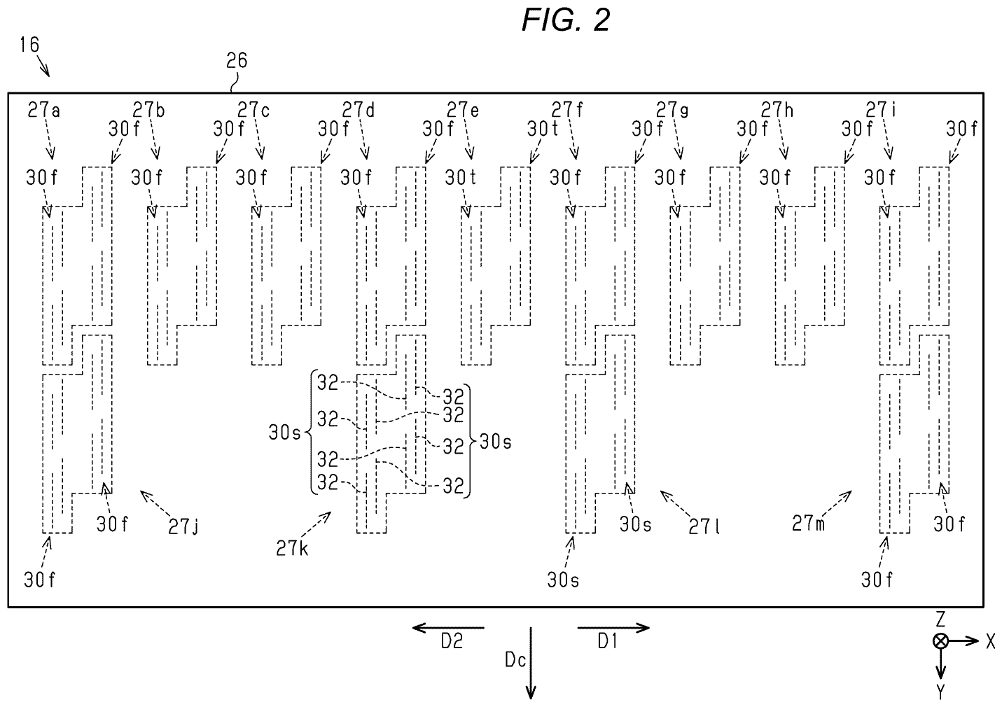

As shown in FIG. 2, the liquid ejection unit 16 in the present embodiment includes the thirteen heads 27. The plurality of heads 27 is also referred to as a first head 27a through a thirteenth head 27m when distinguished from each other. The first head 27a through the ninth head 27i can be disposed side by side in the first direction D1. The tenth head 27j through the thirteenth head 27m can be disposed side by side in the first direction D1. The tenth head 27j through the thirteenth head 27m can be disposed downstream of the first head 27a through the ninth head 27i in the conveyance direction Dc.

The first head 27a and the tenth head 27j can be disposed side by side in the conveyance direction Dc. The fourth head 27d and the eleventh head 27k can be disposed side by side in the conveyance direction Dc. The sixth head 27f and the twelfth head 27l can be disposed side by side in the conveyance direction Dc. The ninth head 27i and the thirteenth head 27m can be disposed side by side in the conveyance direction Dc.

In the present embodiment, the plurality of nozzle groups 30 provided to the liquid ejection unit 16 is also referred to as a first nozzle group 30f, a second nozzle group 30s, and a third nozzle group 30t. That is, the liquid ejection unit 16 includes the first nozzle group 30f and the second nozzle group 30s. The liquid ejection unit 16 can also include the third nozzle group 30t. The liquid ejection unit 16 can include a plurality of first nozzle groups 30f, a plurality of second nozzle groups 30s, and a plurality of third nozzle groups 30t. Each of the heads 27 in the present embodiment can include two of the plurality of first nozzle groups 30f, the plurality of second nozzle groups 30s, and the plurality of third nozzle groups 30t.

The nozzle group 30 can include one or more nozzle arrays 32. The nozzle array 32 is formed of the plurality of nozzles 29 arranged side by side in the conveyance direction Dc. In the present embodiment, the nozzle group 30 is formed of four nozzle arrays 32. The four nozzle arrays 32 constituting one nozzle group 30 are positioned so as to be shifted in the first direction D1 and the conveyance direction Dc from each other.

For example, each of the first head 27a through the fourth head 27d, the sixth head 27f through the tenth head 27j, and the thirteenth head 27m includes two first nozzle groups 30f. For example, the fifth head 27e includes two third nozzle groups 30t. For example, each of the eleventh head 27k and the twelfth head 27l has two second nozzle groups 30s.

The first nozzle group 30f is capable of ejecting a first liquid. The first liquid is different from a second liquid. The first liquid is, for example, aqueous ink. The first liquid is, for example, ink constituting a color of an image to be printed on the cloth 21. The first liquid is, for example, pigment ink. The first liquid can include, for example, transparent overcoat ink. The plurality of first nozzle groups 30f can be capable of ejecting ink of respective colors different from each other.

The second nozzle group 30s is capable of ejecting the second liquid. The second liquid is a liquid containing a softening agent. The softening agent is not particularly limited as long as flexibility and water repellency can be provided to the cloth 21, but a silicone compound is preferable. As an example of the silicone compound, there can be cited dimethyl silicone oil. The second nozzle group 30s is capable of performing a softening treatment of ejecting the second liquid onto the cloth 21. By performing the softening treatment, the color forming property of the image to be printed can be enhanced.

The third nozzle group 30t is capable of ejecting the third liquid. The third liquid is a liquid containing an aggregating agent having a component that aggregates the first liquid. The third liquid fixes the first liquid attached to the cloth 21.

The second nozzle group 30s can be disposed downstream of the first nozzle group 30f and the third nozzle group 30t in the conveyance direction Dc. For example, the eleventh head 27k and the twelfth head 27l having the second nozzle group 30s can be disposed downstream of the first head 27a through the ninth head 27i having the first nozzle group 30f and the third nozzle group 30t in the conveyance direction Dc.

The fifth head 27e is located at a first direction D1 side of the eleventh head 27k. That is, the third nozzle group 30t provided to the fifth head 27e is located at the first direction D1 side of the second nozzle group 30s provided to the eleventh head 27k.

The fifth head 27e is located at a second direction D2 side of the twelfth head 27l. That is, the third nozzle group 30t provided to the fifth head 27e is located at the second direction D2 side of the second nozzle group 30s provided to the twelfth head 27l.

### Maintenance Unit

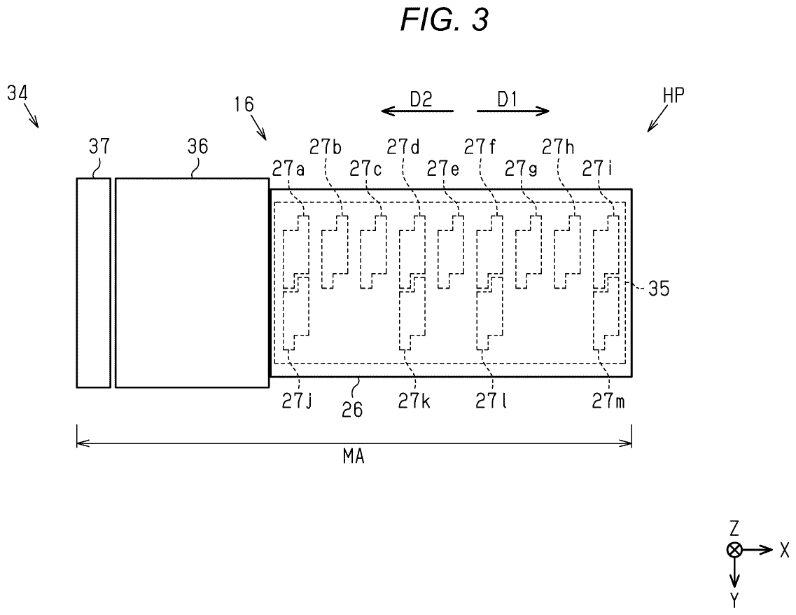

As shown in FIG. 3, the liquid ejection apparatus 11 can include a maintenance unit 34. The maintenance unit 34 can include a cap 35, a first maintenance receiving unit 36, and a second maintenance receiving unit 37. The cap 35, the first maintenance receiving unit 36, and the second maintenance receiving unit 37 may be disposed in a maintenance area MA. The cap 35, the first maintenance receiving unit 36, and the second maintenance receiving unit 37 may be disposed in this order in the second direction D2.

The liquid ejection unit 16 can be located at a home position HP in a standby state in which printing is not performed. The cap 35 makes contact with the liquid ejection unit 16 located at the home position HP to cap the liquid ejection unit 16.

The liquid ejection unit 16 can perform the waste ejection in which the liquid is ejected from the nozzles 29 as waste liquid, for example, before printing, or after cleaning in which the liquid is forcibly discharged from the head 27. The waste ejection of the liquid is also referred to as flushing.

### Method of Controlling Liquid Ejection Apparatus

When the glue belt 17 stops conveying the cloth 21, the liquid ejection unit 16 performs the waste ejection of the liquid to the first maintenance receiving unit 36 and the second maintenance receiving unit 37. The liquid ejection unit 16 moves from the home position HP in the second direction D2 to perform the waste ejection of the liquid.

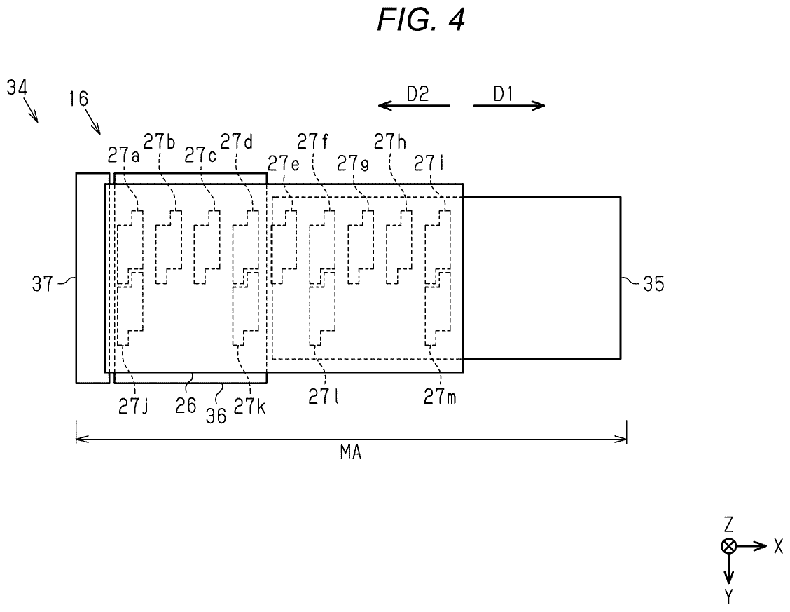

As shown in FIG. 4, the liquid ejection unit 16 moves to a first maintenance position. The first maintenance position is a position where the first head 27a through the fourth head 27d, the tenth head 27j, and the eleventh head 27k are opposed to the first maintenance receiving unit 36. At the first maintenance position, the liquid ejection unit 16 makes the first head 27a through the fourth head 27d, the tenth head 27j, and the eleventh head 27k perform the waste ejection.

That is, the first nozzle group 30f of the first head 27a through the fourth head 27d and the tenth head 27j performs the waste ejection of the first liquid to the first maintenance receiving unit 36. The second nozzle group 30s of the eleventh head 27k performs the waste ejection of the second liquid to the first maintenance receiving unit 36.

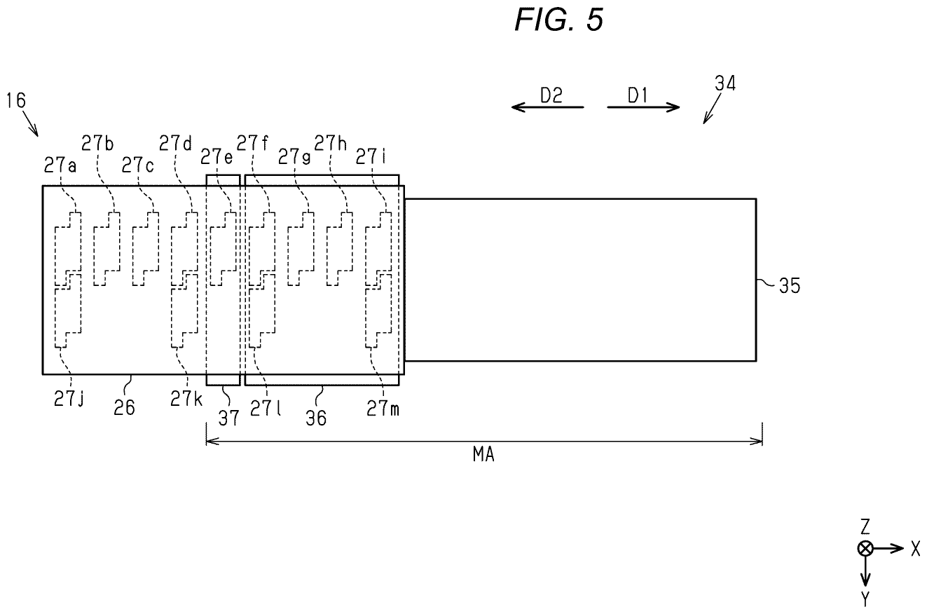

As shown in FIG. 5, the liquid ejection unit 16 moves to a second maintenance position. The second maintenance position is a position where the fifth head 27e is opposed to the second maintenance receiving unit 37, and the sixth head 27f through the ninth head 27i, the twelfth head 27l, and the thirteenth head 27m are opposed to the first maintenance receiving unit 36. At the second maintenance position, the liquid ejection unit 16 makes the fifth head 27e through the ninth head 27i, the twelfth head 27l, and the thirteenth head 27m perform the waste ejection.

That is, the third nozzle group 30t of the fifth head 27e performs the waste ejection of the third liquid to the second maintenance receiving unit 37. The first nozzle group 30f of the sixth head 27f through the ninth head 27i and the thirteenth head 27m performs the waste ejection of the first liquid to the first maintenance receiving unit 36. The second nozzle group 30s of the twelfth head 27l performs the waste ejection of the second liquid to the first maintenance receiving unit 36.

### Softening Agent Receiving Unit and Aggregating Agent Receiving Unit

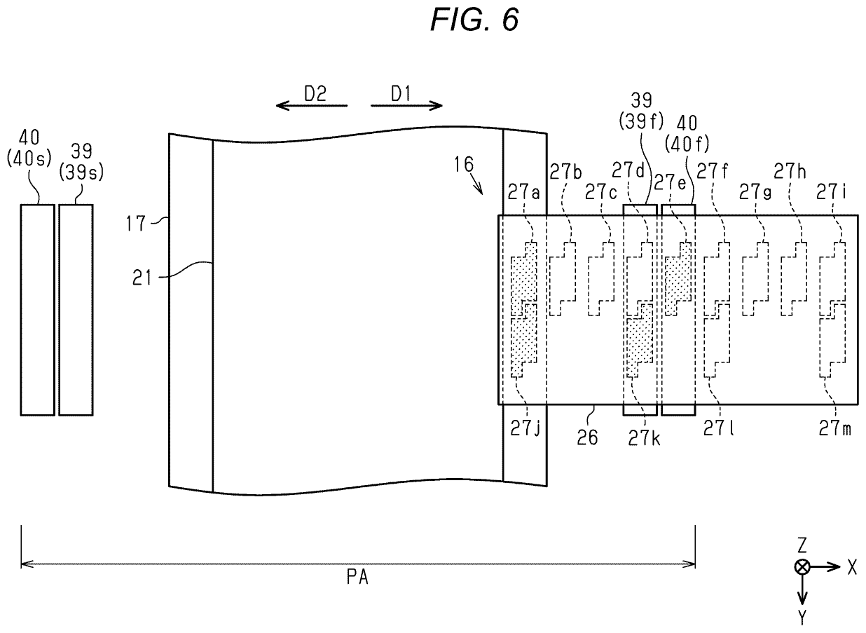

As shown in FIG. 6, the liquid ejection apparatus 11 includes a softening agent receiving unit 39. The liquid ejection apparatus 11 can include an aggregating agent receiving unit 40. The liquid ejection apparatus 11 can include a plurality of softening agent receiving units 39 and a plurality of aggregating agent receiving units 40. The liquid ejection apparatus 11 according to the present embodiment includes a first softening agent receiving unit 39f, a second softening agent receiving unit 39s, a first aggregating agent receiving unit 40f, and a second aggregating agent receiving unit 40s.

The glue belt 17, the first softening agent receiving unit 39f, the second softening agent receiving unit 39s, the first aggregating agent receiving unit 40f, and the second aggregating agent receiving unit 40s can be disposed in a printing area PA. The printing area PA is an area where printing is performed on the cloth 21. The printing area PA can also be an area that is opposed to the head 27 during performing printing on the cloth 21. The head 27 performs printing on the cloth 21 in the printing area PA. A distance between the glue belt 17 and each of the first softening agent receiving unit 39f, the second softening agent receiving unit 39s, the first aggregating agent receiving unit 40f, and the second aggregating agent receiving unit 40s is shorter than a distance between the maintenance unit 34 and the glue belt 17.

The first softening agent receiving unit 39f and the second softening agent receiving unit 39s are disposed across the glue belt 17 in the first direction D1. The first aggregating agent receiving unit 40f and the second aggregating agent receiving unit 40s are disposed across the glue belt 17, the first softening agent receiving unit 39f, and the second softening agent receiving unit 39s in the first direction D1.

The first softening agent receiving unit 39f and the first aggregating agent receiving unit 40f can be located at the first direction D1 side of the glue belt 17. The first softening agent receiving unit 39f is disposed between the glue belt 17 and the first aggregating agent receiving unit 40f in the first direction D1.

The second softening agent receiving unit 39s and the second aggregating agent receiving unit 40s can be located at the second direction D2 side of the glue belt 17. The second softening agent receiving unit 39s is disposed between the glue belt 17 and the second aggregating agent receiving unit 40s in the second direction D2.

### Method of Controlling Liquid Ejection Apparatus

When the glue belt 17 conveys the cloth 21, the liquid ejection unit 16 performs the waste ejection of the liquids to the glue belt 17, the softening agent receiving unit 39, and the aggregating agent receiving unit 40. That is, the liquid ejection unit 16 performs the waste ejection to be performed during the printing, to the glue belt 17, the softening agent receiving unit 39, and the aggregating agent receiving unit 40. When performing printing on the cloth 21, the controller 12 alternately performs rotation of the glue belt 17 and movement of the liquid ejection unit 16. When the glue belt 17 rotates, the cleaning mechanism 14 cleans the glue belt 17. When the cleaning mechanism 14 cleans the glue belt 17, the liquid ejection unit 16 performs the waste ejection of the liquid to the glue belt 17.

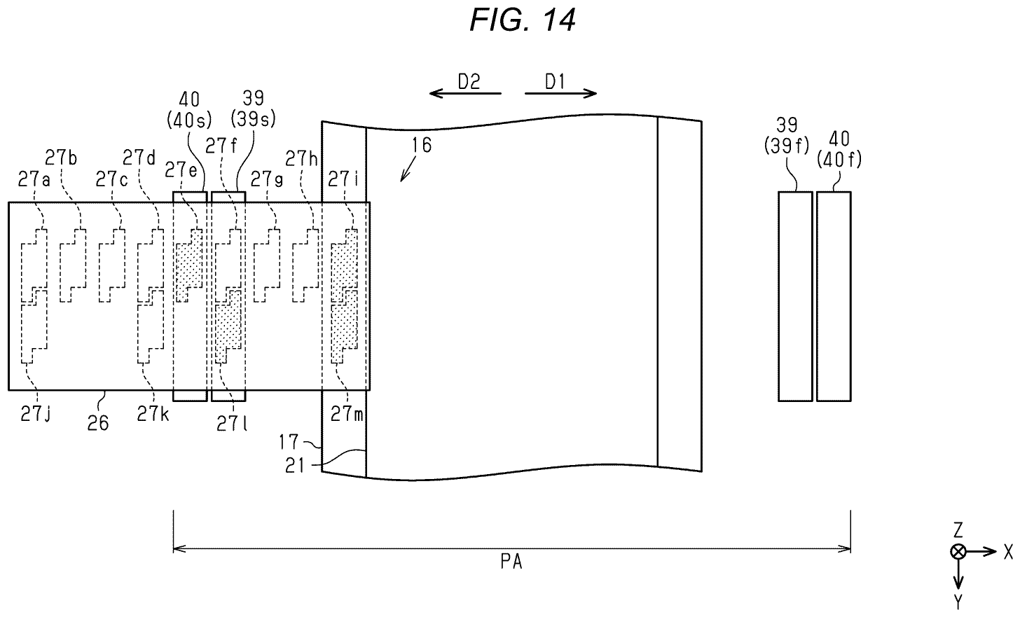

When printing is performed on the cloth 21, the liquid ejection unit 16 reciprocates between a first end position shown in FIG. 6 and a second end position shown in FIG. 14. The liquid ejection unit 16 ejects the liquid toward the cloth 21 to perform printing. The liquid ejection unit 16 ejects the liquid toward an object different from the cloth 21 to thereby discharge the liquid as the waste liquid.

The liquid ejection unit 16 shown in FIG. 6 is located at the first end position. The first head 27a and the tenth head 27j are opposed to the glue belt 17. The fourth head 27d and the eleventh head 27k are opposed to the first softening agent receiving unit 39f. The fifth head 27e is opposed to the first aggregating agent receiving unit 40f.

The first nozzle group 30f of the first head 27a and the tenth head 27j performs the waste ejection of the first liquid to the glue belt 17. The fourth head 27d does not perform the waste ejection. The second nozzle group 30s of the eleventh head 27k performs the waste ejection of the second liquid to the first softening agent receiving unit 39f. The third nozzle group 30t of the fifth head 27e performs the waste ejection of the third liquid to the first aggregating agent receiving unit 40f.

The movement mechanism 15 moves the liquid ejection unit 16 toward the second direction D2. Every time the liquid ejection unit 16 moves by a distance corresponding to the size of the head 27, the liquid ejection unit 16 makes some of the heads 27 perform the waste ejection of the liquid. In FIG. 6 through FIG. 21, the head 27 that performs the waste ejection is indicated with hatching.

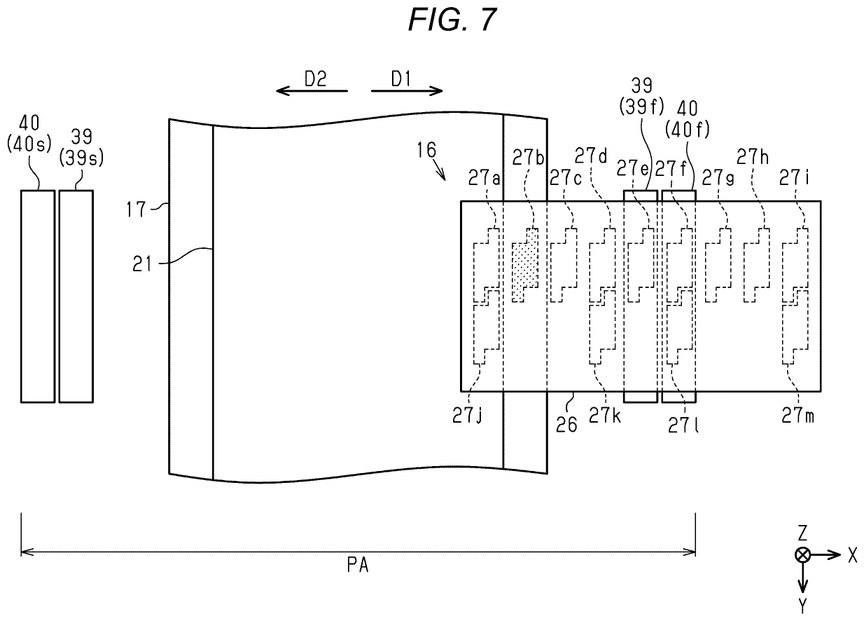

As shown in FIG. 7, the liquid ejection unit 16 moving toward the second direction D2 ejects the liquid from the second head 27b at a timing when the second head 27b is opposed to the glue belt 17. The first nozzle group 30f of the second head 27b performs the waste ejection of the first liquid to the glue belt 17.

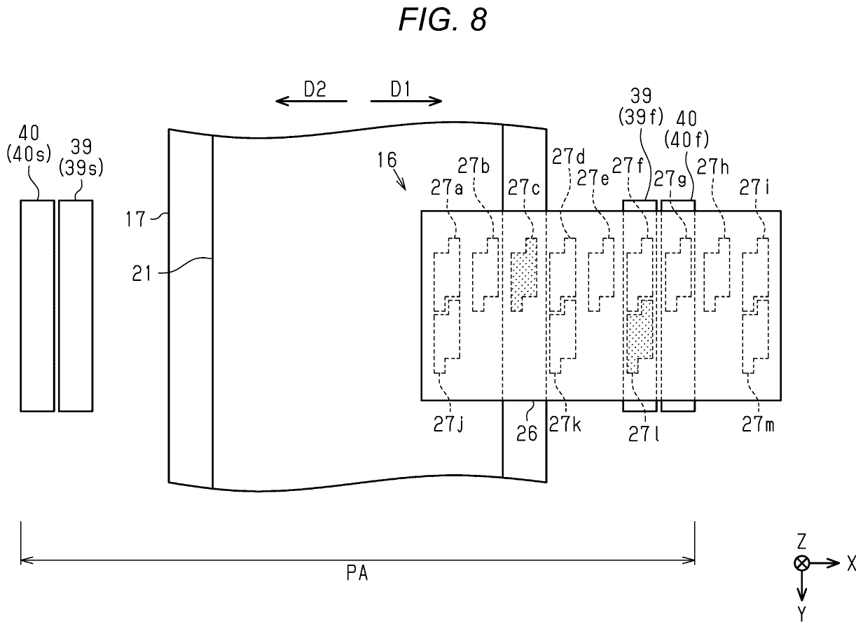

As shown in FIG. 8, the liquid ejection unit 16 moving toward the second direction D2 ejects the liquid from the third head 27c at a timing when the third head 27c is opposed to the glue belt 17. The first nozzle group 30f of the third head 27c performs the waste ejection of the first liquid to the glue belt 17. At this time, the twelfth head 27l is opposed to the first softening agent receiving unit 39f. The second nozzle group 30s of the twelfth head 27l performs the waste ejection of the second liquid to the first softening agent receiving unit 39f.

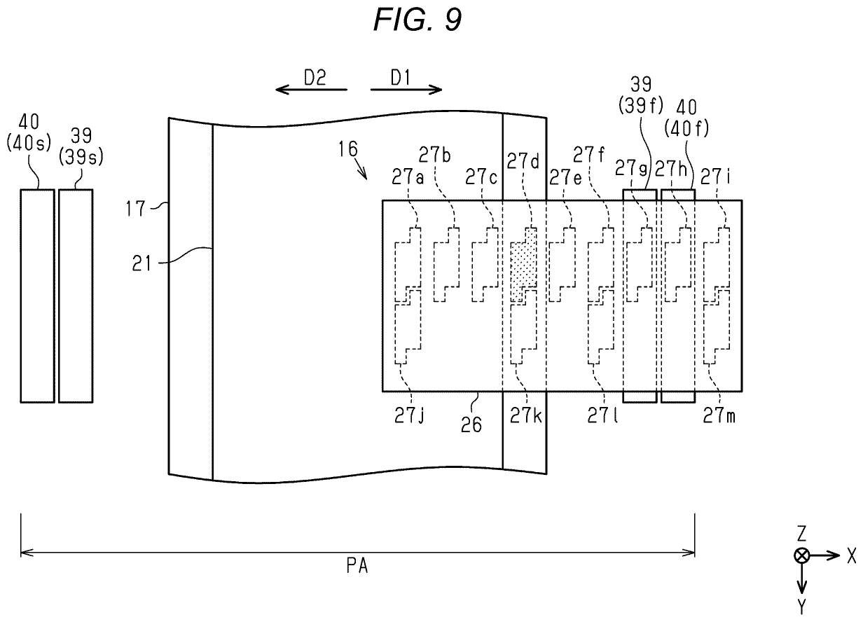

As shown in FIG. 9, the liquid ejection unit 16 moving toward the second direction D2 ejects the liquid from the fourth head 27d at a timing when the fourth head 27d and the eleventh head 27k are opposed to the glue belt 17. The first nozzle group 30f of the fourth head 27d performs the waste ejection of the first liquid to the glue belt 17.

The liquid ejection unit 16 does not perform the waste ejection of the liquid at a timing when the fifth head 27e is opposed to the glue belt 17, and therefore, the illustration thereof is omitted.

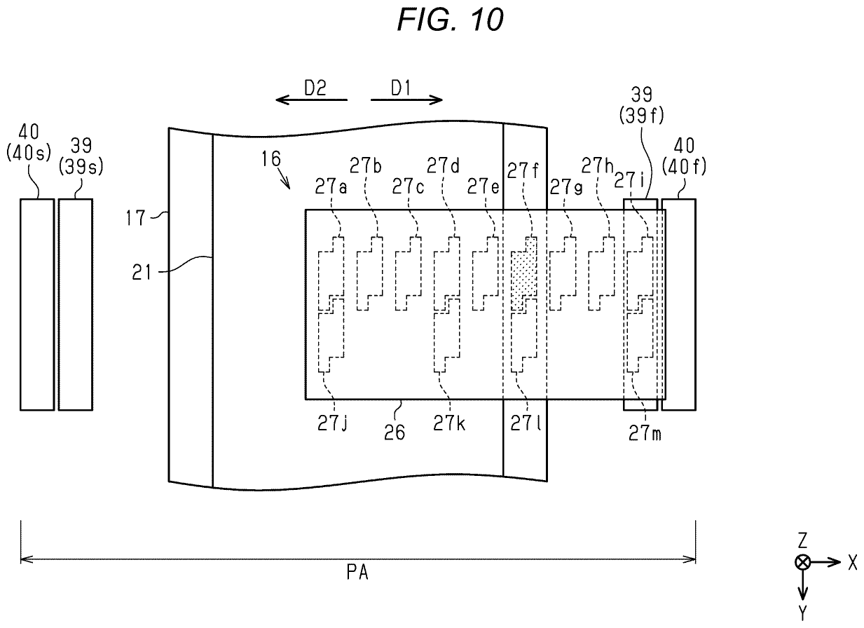

As shown in FIG. 10, the liquid ejection unit 16 moving toward the second direction D2 ejects the liquid from the sixth head 27f at a timing when the sixth head 27f and the twelfth head 27l are opposed to the glue belt 17. The first nozzle group 30f of the sixth head 27f performs the waste ejection of the first liquid to the glue belt 17.

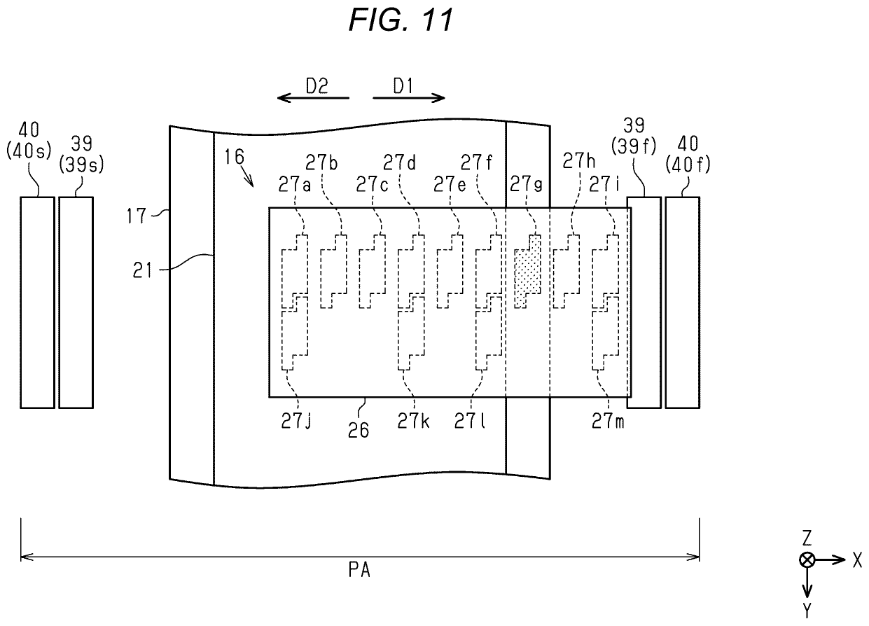

As shown in FIG. 11, the liquid ejection unit 16 moving toward the second direction D2 ejects the liquid from the seventh head 27g at a timing when the seventh head 27g is opposed to the glue belt 17. The first nozzle group 30f of the seventh head 27g performs the waste ejection of the first liquid to the glue belt 17.

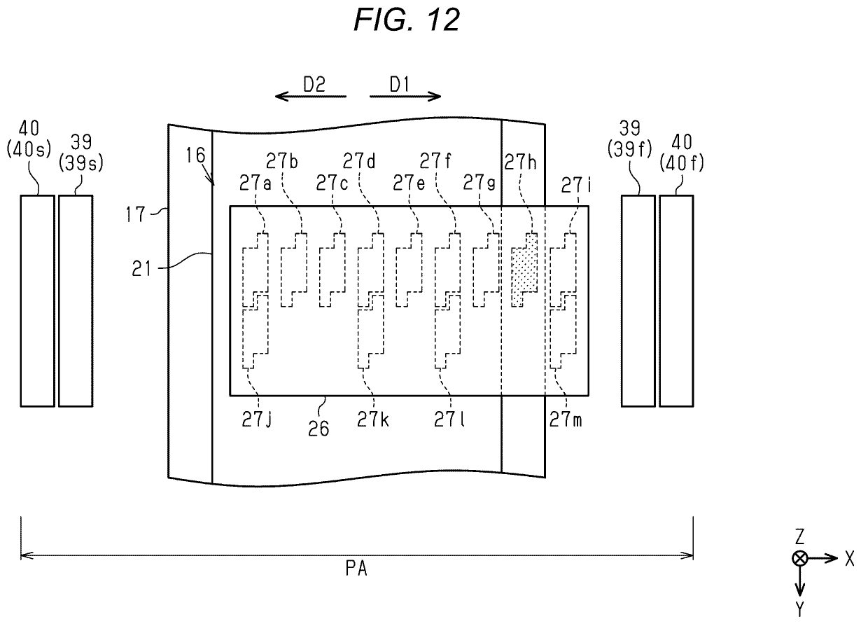

As shown in FIG. 12, the liquid ejection unit 16 moving toward the second direction D2 ejects the liquid from the eighth head 27h at a timing when the eighth head 27h is opposed to the glue belt 17. The first nozzle group 30f of the eighth head 27h performs the waste ejection of the first liquid to the glue belt 17.

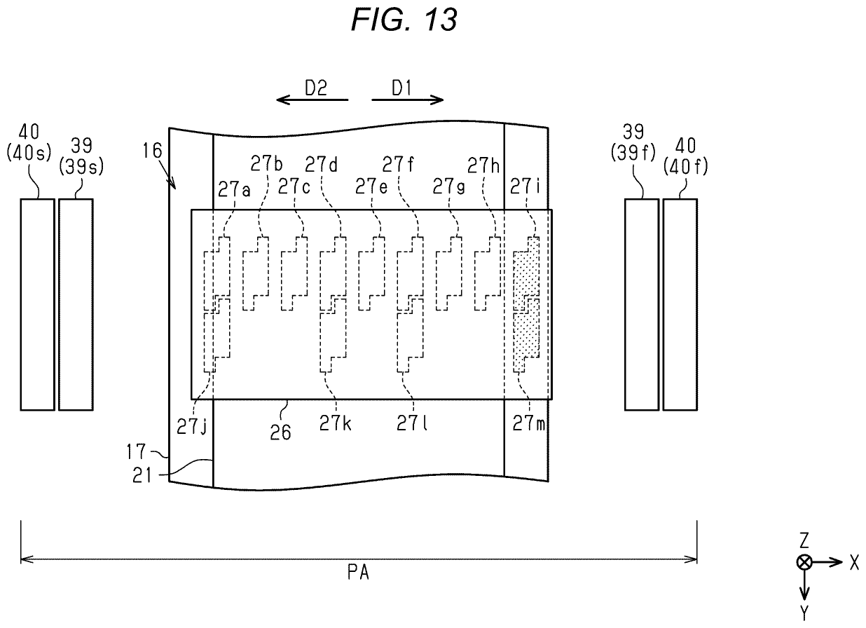

As shown in FIG. 13, the liquid ejection unit 16 moving toward the second direction D2 ejects the liquid from the ninth head 27i and the thirteenth head 27m at a timing when the ninth head 27i and the thirteenth head 27m are opposed to the glue belt 17. The first nozzle group 30f of the ninth head 27i and the thirteenth head 27m performs the waste ejection of the first liquid to the glue belt 17. The liquid ejection unit 16 moves toward the second direction D2 to the second end position shown in FIG. 14.

The liquid ejection unit 16 shown in FIG. 14 is located at the second end position. The ninth head 27i and the thirteenth head 27m are opposed to the glue belt 17. The sixth head 27f and the twelfth head 27l are opposed to the second softening agent receiving unit 39s. The fifth head 27e is opposed to the second aggregating agent receiving unit 40s.

The first nozzle group 30f of the ninth head 27i and the thirteenth head 27m performs the waste ejection of the first liquid to the glue belt 17. The sixth head 27f does not perform the waste ejection. The second nozzle group 30s of the twelfth head 27l performs the waste ejection of the second liquid to the second softening agent receiving unit 39s. The third nozzle group 30t of the fifth head 27e performs the waste ejection of the third liquid to the second aggregating agent receiving unit 40s. The movement mechanism 15 moves the liquid ejection unit 16 toward the first direction D1.

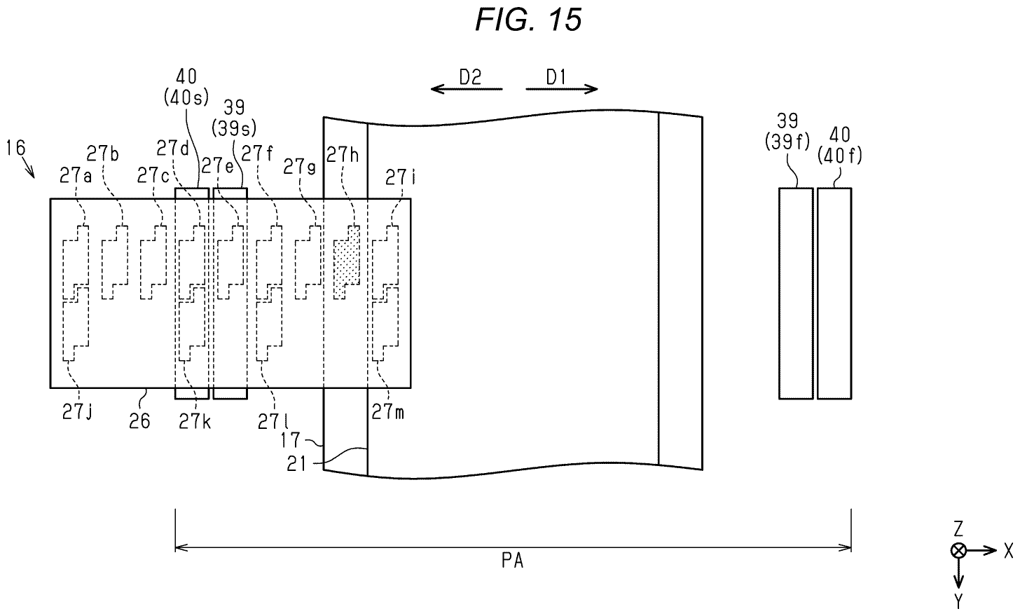

As shown in FIG. 15, the liquid ejection unit 16 moving toward the first direction D1 ejects the liquid from the eighth head 27h at the timing when the eighth head 27h is opposed to the glue belt 17. The first nozzle group 30f of the eighth head 27h performs the waste ejection of the first liquid to the glue belt 17.

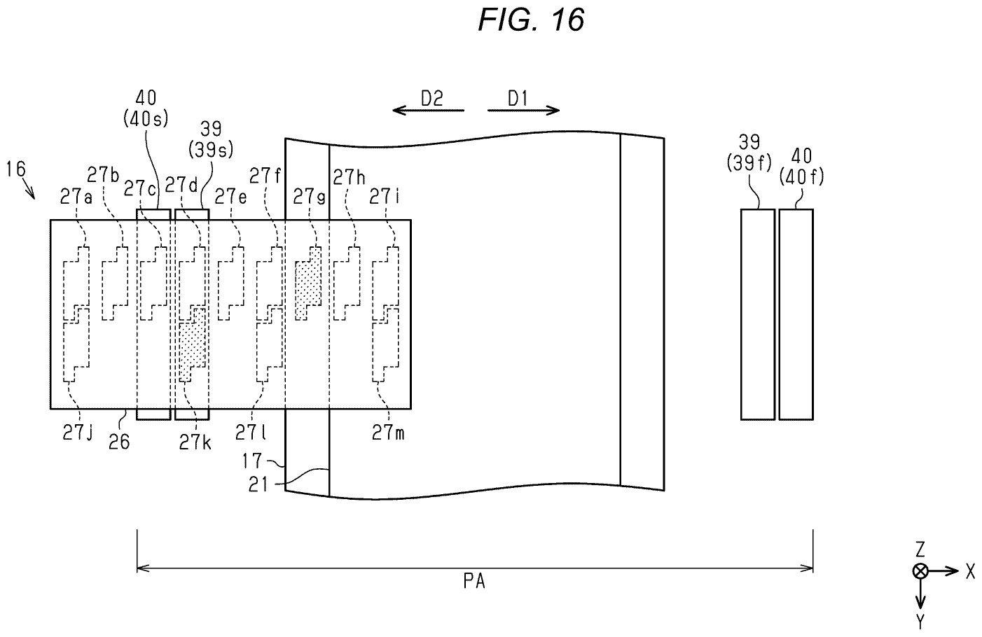

As shown in FIG. 16, the liquid ejection unit 16 moving toward the first direction D1 ejects the liquid from the seventh head 27g at the timing when the seventh head 27g is opposed to the glue belt 17. The first nozzle group 30f of the seventh head 27g performs the waste ejection of the first liquid to the glue belt 17. At this time, the eleventh head 27k is opposed to the second softening agent receiving unit 39s. The second nozzle group 30s of the eleventh head 27k performs the waste ejection of the second liquid to the second softening agent receiving unit 39s.

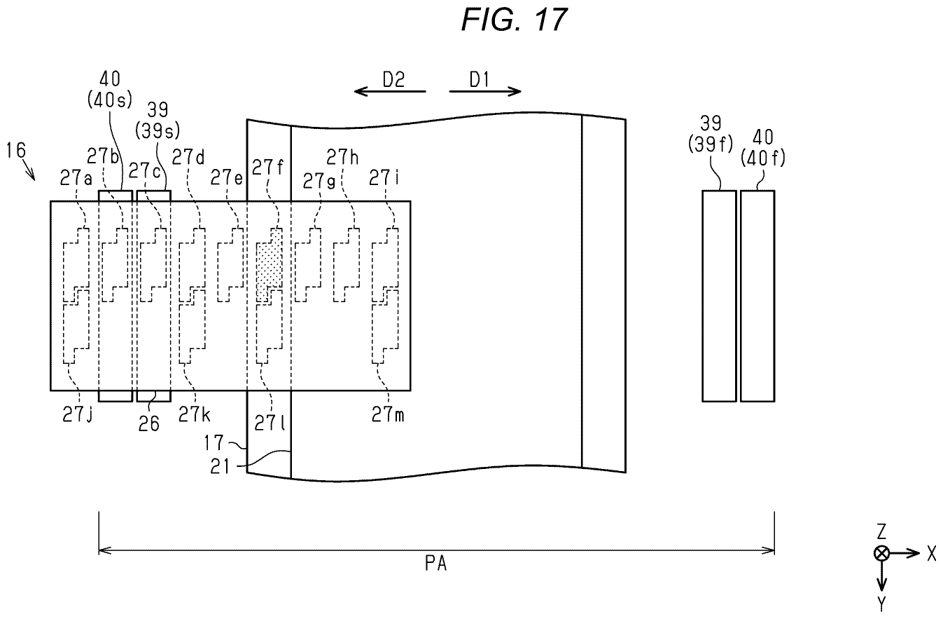

As shown in FIG. 17, the liquid ejection unit 16 moving toward the first direction D1 ejects the liquid from the sixth head 27f at the timing when the sixth head 27f and the twelfth head 27l are opposed to the glue belt 17. The first nozzle group 30f of the sixth head 27f performs the waste ejection of the first liquid to the glue belt 17.

The liquid ejection unit 16 does not perform the waste ejection of the liquid at the timing when the fifth head 27e is opposed to the glue belt 17, and therefore, the illustration thereof is omitted.

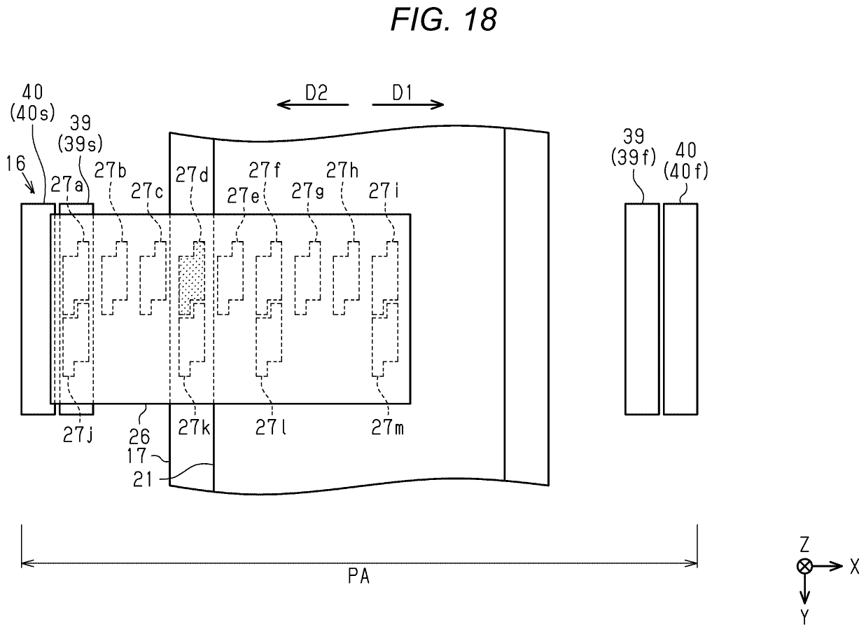

As shown in FIG. 18, the liquid ejection unit 16 moving toward the first direction D1 ejects the liquid from the fourth head 27d at the timing when the fourth head 27d and the eleventh head 27k are opposed to the glue belt 17. The first nozzle group 30f of the fourth head 27d performs the waste ejection of the first liquid to the glue belt 17.

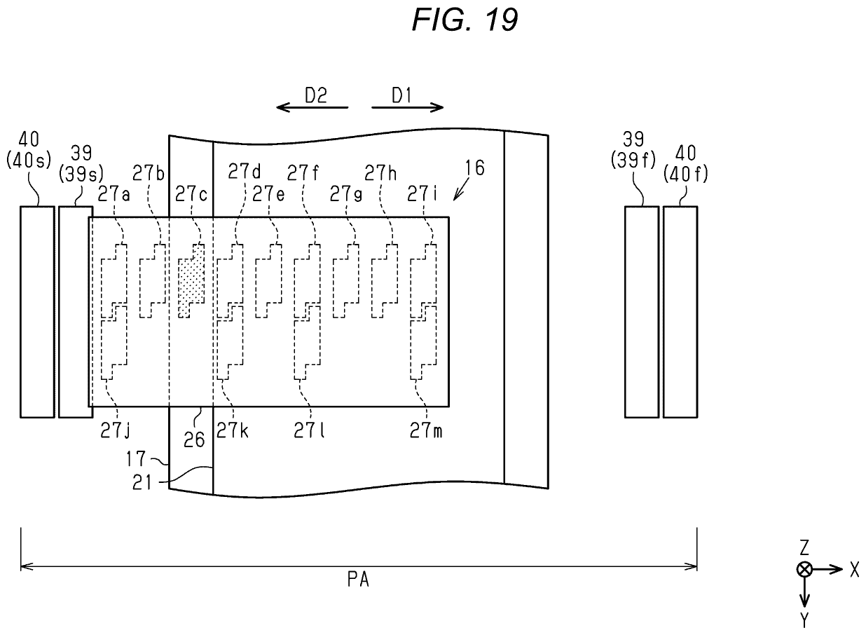

As shown in FIG. 19, the liquid ejection unit 16 moving toward the first direction D1 ejects the liquid from the third head 27c at the timing when the third head 27c is opposed to the glue belt 17. The first nozzle group 30f of the third head 27c performs the waste ejection of the first liquid to the glue belt 17.

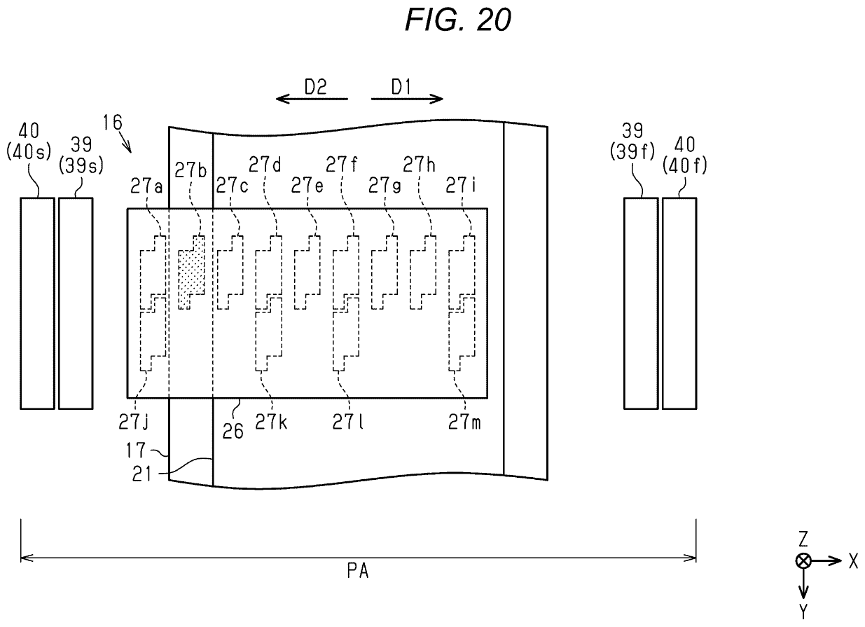

As shown in FIG. 20, the liquid ejection unit 16 moving toward the first direction D1 ejects the liquid from the second head 27b at the timing when the second head 27b is opposed to the glue belt 17. The first nozzle group 30f of the second head 27b performs the waste ejection of the first liquid to the glue belt 17.

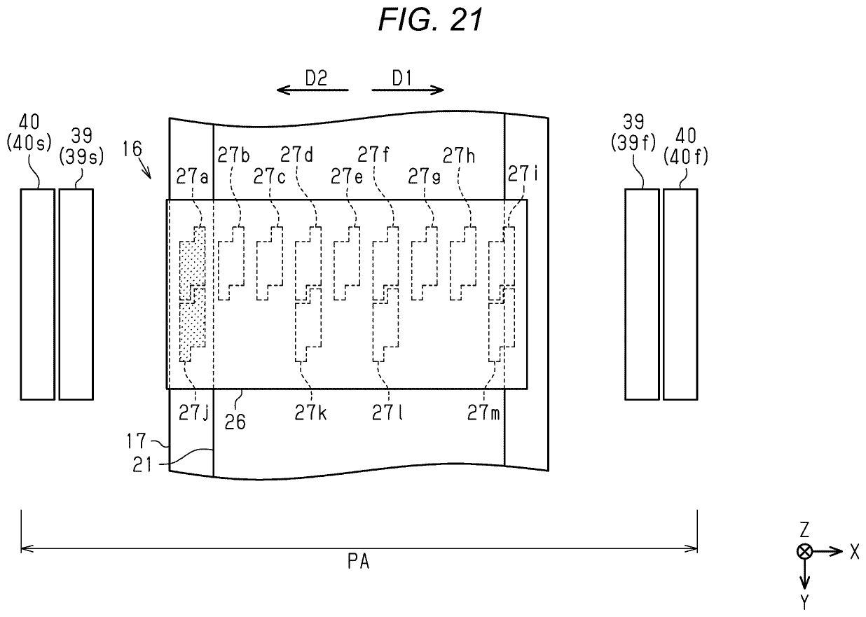

As shown in FIG. 21, the liquid ejection unit 16 moving toward the first direction D1 ejects the liquid from the first head 27a and the tenth head 27j at a timing when the first head 27a and the tenth head 27j are opposed to the glue belt 17. The first nozzle group 30f of the first head 27a and the tenth head 27j performs the waste ejection of the first liquid to the glue belt 17. The liquid ejection unit 16 moves toward the first direction D1 to the first end position.

### Operation of Embodiment

The operation of the present embodiment will be described.

The glue belt 17 supports the cloth 21, and receives the first liquid discharged as the waste liquid. The first liquid received by the glue belt 17 is cleaned by the cleaning unit 22.

The first softening agent receiving unit 39f and the second softening agent receiving unit 39s receive the second liquid that is discharged as the waste liquid from the liquid ejection unit 16 reciprocated by the movement mechanism 15. The first aggregating agent receiving unit 40f and the second aggregating agent receiving unit 40s receive the third liquid that is discharged as the waste liquid from the liquid ejection unit 16 reciprocated by the movement mechanism 15.

### Advantages of Embodiment

Advantage of the present embodiment will be described.

(1) The second nozzle group 30s performs the waste ejection of the second liquid containing the softening agent to the softening agent receiving unit 39. Therefore, it is possible to prevent a decrease in adherence property of the glue belt 17 compared to, for example, when performing the waste ejection of the second liquid to the glue belt 17.

(2) The third nozzle group 30t is capable of ejecting the third liquid. Since the third liquid aggregates the first liquid, the quality of printing can be improved.

(3) When performing the waste ejection of the third liquid to the glue belt 17, there is a possibility that the first liquid aggregates on the glue belt 17 to make cleaning difficult. In this regard, the third nozzle group 30t performs the waste ejection of the third liquid to the aggregating agent receiving unit 40. Accordingly, aggregation of the first liquid on the glue belt 17 can be prevented.

(4) The second nozzle group 30s is disposed downstream of the first nozzle group 30f and the third nozzle group 30t in the conveyance direction Dc. That is, since the second nozzle group 30s ejects the second liquid to the cloth 21 to which the first liquid and the third liquid have been attached, it is possible to smooth the surface to enhance the color forming property.

(5) The glue belt 17, the first softening agent receiving unit 39f, and the first aggregating agent receiving unit 40f are arranged in this order in the first direction D1. The third nozzle group 30t is arranged at the first direction D1 side of the second nozzle group 30s of the eleventh head 27k. Accordingly, compared to when the second nozzle group 30s of the eleventh head 27k is disposed at the first direction D1 side of the third nozzle group 30t, it is possible to shorten the distance of the reciprocation of the liquid ejection unit 16.

(6) When the conveyance of the cloth 21 is stopped, the liquid ejection unit 16 is located in the maintenance area MA. The first maintenance receiving unit 36 and the second maintenance receiving unit 37 are disposed in the maintenance area MA. Therefore, it is possible to shorten the time required for the waste ejection by performing the waste ejection of the first liquid, the second liquid, and the third liquid to the first maintenance receiving unit 36 and the second maintenance receiving unit 37 when the conveyance of the cloth 21 is stopped.

### Modified Examples

The present embodiment can be implemented with the following modifications. The present embodiment and the following modified examples can be implemented in combination with each other as long as no technical inconsistencies are involved.
When the glue belt 17 stops conveying the cloth 21, the liquid ejection unit 16 can perform the waste ejection to the glue belt 17, the softening agent receiving unit 39, and the aggregating agent receiving unit 40. That is, the first nozzle group 30f can perform the waste ejection of the first liquid to the glue belt 17. The second nozzle group 30s can perform the waste ejection of the second liquid to the first softening agent receiving unit 39f or the second softening agent receiving unit 39s. The third nozzle group 30t can perform the waste ejection of the third liquid to the first aggregating agent receiving unit 40f or the second aggregating agent receiving unit 40s.
The third nozzle group 30t can be located at the same position as the position of the second nozzle group 30s in the first direction D1. For example, at least one of the fourth head 27d and the sixth head 27f can include the third nozzle group 30t.
The first aggregating agent receiving unit 40f may be disposed between the glue belt 17 and the first softening agent receiving unit 39f in the first direction D1.
The second aggregating agent receiving unit 40s may be disposed between the glue belt 17 and the second softening agent receiving unit 39s in the second direction D2.
The second nozzle group 30s can be disposed at the same position as the positions of the first nozzle group 30f and the third nozzle group 30t in the conveyance direction Dc. The second nozzle group 30s can be disposed upstream of the first nozzle group 30f and the third nozzle group 30t in the conveyance direction Dc.
The maintenance area MA and the printing area PA can be disposed adjacent to each other in the first direction D1. For example, the first softening agent receiving unit 39f, the first aggregating agent receiving unit 40f, and the maintenance unit 34 can be arranged side by side in the first direction D1. In this case, the maintenance unit 34 can be provided with a configuration in which the second maintenance receiving unit 37 is not provided. When the liquid ejection unit 16 is located at the second maintenance position, the fifth head 27e can be opposed to the first aggregating agent receiving unit 40f, and the sixth head 27f through the ninth head 27i, the twelfth head 27l, and the thirteenth head 27m can be opposed to the first maintenance receiving unit 36. The third nozzle group 30t of the fifth head 27e can perform the waste ejection of the third liquid to the first aggregating agent receiving unit 40f.
The liquid ejection apparatus 11 can be provided with a configuration in which the aggregating agent receiving unit 40 is not provided. The third nozzle group 30t can perform the waste ejection of the third liquid to the glue belt 17 or the softening agent receiving unit 39.
The liquid ejection apparatus 11 can be provided with a configuration in which the third nozzle group 30t is not provided.
Among the plurality of heads 27, the head 27 to be provided with the second nozzle group 30s can be selected at will.
The liquid ejection unit 16 can include a single head 27. In the liquid ejection unit 16, one or more first nozzle groups 30f and one or more second nozzle groups 30s can be provided to a single head 27.
The liquid ejection apparatus 11 can be a liquid ejection apparatus that jets or ejects other liquids than ink. The state of the liquid to be ejected from the liquid ejection apparatus as a minute amount of droplet includes a particle state, a teardrop state, and a state of tailing like a thread. The liquid mentioned here is only required to be a material which can be ejected from the liquid ejection apparatus. For example, the liquid is only required to be in a liquid state of a substance, and includes a liquid material high or low in viscosity, sol, gel water, other inorganic solvents, organic solvents, solutions, and a fluid material such as liquid resin, liquid metal, and metal melt. The liquid includes not only the liquid as a state of a substance, but also a liquid in which particles of a functional material made of a solid such as a pigment or a metal particle are dissolved, dispersed, or mixed in a solvent. As typical examples of the liquid, there can be cited the ink, liquid crystal, and so on explained in the embodiment described above. Here, the ink includes various types of liquid compositions such as general water-based ink, oil-based ink, gel ink, and hot melt ink. As a specific example of the liquid ejection apparatus, there is a device that ejects a liquid containing a material such as an electrode material or a coloring material used in, for example, manufacture of a liquid crystal display, an electroluminescence display, a surface-emitting display, and a color filter in a dispersed or dissolved form. The liquid ejection apparatus can be an apparatus that ejects a bioorganic substance used for manufacturing a biochip, an apparatus that is used as a precision pipette and ejects liquid to be a sample, a textile printing apparatus, a micro dispenser, or the like. The liquid ejection apparatus can be an apparatus that ejects lubricating oil to a precision machine such as a timepiece or a camera in a pinpoint manner, or an apparatus that ejects a transparent resin liquid such as ultraviolet curing resin onto a substrate in order to form a minute hemispherical lens, an optical lens, or the like used for an optical communication element or the like. The liquid ejection apparatus can be an apparatus that ejects an etching liquid such as acid or alkali in order to etch a substrate or the like.

### Definition

The expression “at least one” used in this specification means “one or more” of desired options. For example, the expression “at least one” used in the specification means “just one option” or “both of two options” when the number of options is two. As another example, the expression “at least one” used in the specification means “just one option” or “a combination of any two or more options” when the number of options is three or more.

### APPENDIX

In the following description, technical ideas figured out from the embodiment and the modified examples described above and functions and advantages thereof will be described.

(A) A liquid ejection apparatus includes a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid, a movement mechanism configured to reciprocate the liquid ejection unit in a first direction and a second direction opposite to the first direction, a softening agent receiving unit configured to receive the second liquid discharged as a waste liquid from the liquid ejection unit reciprocated by the movement mechanism, and a cleaning unit configured to clean at least a part of the glue belt, wherein the first liquid is different from the second liquid, the second liquid is a liquid containing a softening agent, the first nozzle group is configured to eject the first liquid to the glue belt as a waste, and the second nozzle group is configured to eject the second liquid to the softening agent receiving unit as a waste.

According to this configuration, the second nozzle group ejects the second liquid containing the softening agent to the softening agent receiving unit as a waste. Therefore, it is possible to prevent a decrease in adherence property of the glue belt compared to, for example, when ejecting the second liquid to the glue belt as a waste.

(B) In the liquid ejection apparatus, the liquid ejection unit may further include a third nozzle group configured to eject a third liquid, and the third liquid may be a liquid containing an aggregating agent including a component of aggregating the first liquid.

According to this configuration, the third nozzle group is capable of ejecting the third liquid. Since the third liquid aggregates the first liquid, the quality of printing can be improved.

(C) The liquid ejection apparatus may further include an aggregating agent receiving unit configured to receive the third liquid discharged as a waste liquid from the liquid ejection unit reciprocated by the movement mechanism, wherein the third nozzle group may eject the third liquid to the aggregating agent receiving unit as a waste.

When the third liquid is ejected to the glue belt as a waste, there is a possibility that the first liquid aggregates on the glue belt, and cleaning becomes difficult. In this regard, according to this configuration, the third nozzle group ejects the third liquid to the aggregating agent receiving unit as a waste. Accordingly, aggregation of the first liquid on the glue belt can be prevented.

(D) In the liquid ejection apparatus, the second nozzle group may be disposed downstream of the first nozzle group and the third nozzle group in a conveyance direction of the cloth conveyed by the glue belt.

According to this configuration, the second nozzle group is disposed downstream of the first nozzle group and the third nozzle group in the conveyance direction. That is, since the second nozzle group ejects the second liquid to the cloth to which the first liquid and the third liquid have been attached, it is possible to smooth the surface to enhance the color forming property.

(E) In the liquid ejection apparatus, the aggregating agent receiving unit may be located at the first direction side of the glue belt, the third nozzle group may be located at the first direction side of the second nozzle group, and the softening agent receiving unit may be disposed between the glue belt and the aggregating agent receiving unit in the first direction.

According to this configuration, the glue belt, the softening agent receiving unit, and the aggregating agent receiving unit are arranged in this order in the first direction. The third nozzle group is disposed at the first direction side of the second nozzle group. Accordingly, compared to when the second nozzle group is disposed at the first direction side of the third nozzle it is possible to shorten a distance of the reciprocation of the liquid ejection unit.

(F) The liquid ejection apparatus may further include a first maintenance receiving unit and a second maintenance receiving unit disposed in a maintenance area, the maintenance area is a area where the liquid ejection unit is located when the glue belt stops conveying the cloth, wherein when the glue belt conveys the cloth, the first nozzle group may eject the first liquid to the glue belt as a waste, and the second nozzle group may eject the second liquid to the softening agent receiving unit as a waste, and when the glue belt stops conveying the cloth, the first nozzle group may eject the first liquid to the first maintenance receiving unit as a waste, the second nozzle group may eject the second liquid to the first maintenance receiving unit as a waste, and the third nozzle group may eject the third liquid to the second maintenance receiving unit as a waste. When the conveyance of the cloth is stopped, the liquid ejection unit is located in the maintenance area. According to this configuration, the first maintenance receiving unit and the second maintenance receiving unit are disposed in the maintenance area. Therefore, it is possible to shorten the time required for the ejection as a waste by ejecting the first liquid, the second liquid, and the third liquid to the first maintenance receiving unit and the second maintenance receiving unit as a waste when the conveyance of the cloth is stopped.

(G) A method of controlling a liquid ejection apparatus is a method of controlling a liquid ejection apparatus including a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid, a movement mechanism configured to reciprocate the liquid ejection unit in a first direction and a second direction opposite to the first direction, a softening agent receiving unit configured to receive the second liquid discharged as a waste liquid from the liquid ejection unit reciprocated by the movement mechanism, and a cleaning unit configured to clean at least a part of the glue belt, wherein the first liquid is different from the second liquid, and the second liquid is a liquid containing a softening agent, the method including ejecting, by the first nozzle group, the first liquid to the glue belt as a waste, and ejecting, by the second nozzle group, the second liquid to the softening agent receiving unit as a waste.

According to this method, it is possible to achieve substantially the same advantages as those of the liquid ejection apparatus described above.

What is claimed is:

1. A liquid ejection apparatus comprising:
a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid;
a movement mechanism configured to reciprocate the liquid ejection unit in a first direction and a second direction opposite to the first direction;
a softening agent receiving unit configured to receive the second liquid discharged as a waste liquid from the liquid ejection unit reciprocated by the movement mechanism; and
a cleaning unit configured to clean at least a part of the glue belt, wherein
the first liquid is different from the second liquid,
the second liquid is a liquid containing a softening agent,
the first nozzle group is configured to eject the first liquid to the glue belt as a waste, and
the second nozzle group is configured to eject the second liquid to the softening agent receiving unit as a waste.

2. The liquid ejection apparatus according to claim 1, wherein
the liquid ejection unit further includes a third nozzle group configured to eject a third liquid, and
the third liquid is a liquid containing an aggregating agent including a component of aggregating the first liquid.

3. The liquid ejection apparatus according to claim 2, further comprising:
an aggregating agent receiving unit configured to receive the third liquid discharged as a waste liquid from the liquid ejection unit reciprocated by the movement mechanism, wherein
the third nozzle group is configured to eject the third liquid to the aggregating agent receiving unit as a waste.

4. The liquid ejection apparatus according to claim 2, wherein
the second nozzle group is disposed downstream of the first nozzle group and the third nozzle group in a conveyance direction of the cloth conveyed by the glue belt.

5. The liquid ejection apparatus according to claim 3, wherein
the aggregating agent receiving unit is located at a side of the first direction of the glue belt,
the third nozzle group is located at the side of the first direction of the second nozzle group, and
the softening agent receiving unit is disposed between the glue belt and the aggregating agent receiving unit in the first direction.

6. The liquid ejection apparatus according to claim 2, further comprising:
a first maintenance receiving unit and a second maintenance receiving unit disposed in a maintenance area, the maintenance area is a area where the liquid ejection unit is located when the glue belt stops conveying the cloth, wherein
when the glue belt conveys the cloth,
the first nozzle group is configured to eject the first liquid to the glue belt as a waste, and
the second nozzle group is configured to eject the second liquid to the softening agent receiving unit as a waste, and
when the glue belt stops conveying the cloth,
the first nozzle group is configured to eject the first liquid to the first maintenance receiving unit as a waste,
the second nozzle group is configured to eject the second liquid to the first maintenance receiving unit as a waste, and
the third nozzle group is configured to eject the third liquid to the second maintenance receiving unit as a waste.

7. A method of controlling a liquid ejection apparatus including
a liquid ejection unit including a glue belt including a conveyance surface which is configured to convey a cloth and to which an adhesive is applied, a first nozzle group configured to eject a first liquid to the cloth conveyed by the glue belt, and a second nozzle group configured to eject a second liquid,
a movement mechanism configured to reciprocate the liquid ejection unit in a first direction and a second direction opposite to the first direction,
a softening agent receiving unit configured to receive the second liquid discharged as a waste liquid from the liquid ejection unit reciprocated by the movement mechanism, and
a cleaning unit configured to clean at least a part of the glue belt, wherein
the first liquid is different from the second liquid, and
the second liquid is a liquid containing a softening agent, the method comprising:
ejecting, by the first nozzle group, the first liquid to the glue belt as a waste; and
ejecting, by the second nozzle group, the second liquid to the softening agent receiving unit as a waste.
